(19) United States
(12) Patent Application Publication
(10) Pub. No.: US 2019/0252098 A1
(43) Pub. Date: Aug. 15, 2019

(54) METHOD OF PRODUCING MAGNETIC MATERIAL

(71) Applicant: NGK INSULATORS, LTD., Nagoya-Shi (JP)

(72) Inventors: Yoshio KIKUCHI, Nagoya-Shi (JP); Yoshimasa KOBAYASHI, Nagoya-Shi (JP)

(73) Assignee: NGK INSULATORS, LTD., Nagoya-Shi (JP)

(21) Appl. No.: 16/396,955

(22) Filed: Apr. 29, 2019

Related U.S. Application Data
(63) Continuation of application No. PCT/JP2017/007950, filed on Feb. 28, 2017.

(30) Foreign Application Priority Data
Nov. 2, 2016 (JP) 2016-215578

(51) Int. Cl. H01F 1/01; B22F 1/00

(52) U.S. Cl. CPC H01F 1/017; B22F 1/0088; B22F 2301/35; B22F 2301/45; B22F 1/0085

(57) ABSTRACT

A method of producing a magnetic material of compound having magnetocaloric effect is disclosed. The method may include producing a product by reacting a raw material that is to constitute the magnetic material in melt including an alkali metal; and removing the alkali metal after the product is cooled.

### TECHNICAL FIELD

The disclosure herein discloses a technique relating to a method of producing a magnetic material of compound having magnetocaloric effect.

### BACKGROUND ART

A magnetic material, of which temperature changes due to entropy therein being changed by a given change in magnetic field, is known. As examples of such magnetic material, gadolinium (Gd) and compounds constituted of plural elements are known. Gd is an expensive metallic material. Therefore, researches for producing a magnetic material with a compound that does not contain Gd have been advanced. Japanese Patent Application Publication No. 2009-68077 describes a technique for producing a magnetic material with a La(Fe, Si)₁₃ compound. Further, Japanese Patent Application Publication No. 2011-523676 describes a technique for producing a magnetic material with a (Mn, Fe)₂(P, Ge) compound.

### SUMMARY OF INVENTION

### Technical Problem

A magnetic material of compound is produced by reacting a melted raw material mixture including plural raw materials and then cooling a product from the reaction to solidify it. However, since a phase diagram of the magnetic material of compound is peritectic, a structure of the product which was cooled and solidified exhibits phase separation. Therefore, a compound having desired magnetocaloric effect cannot be obtained simply by melting the raw material mixture and cooling it. In view of this, conventional techniques subject the product (compound) after cooling to a heat treatment (annealing treatment) for several dozen hours to several hundred hours to uniformize the structure thereof (to make separated phases into a single phase). This takes a long time to produce a magnetic material. The disclosure herein discloses a technique capable of reducing a time to produce a magnetic material of compound, as compared to conventional techniques.

### Solution to Technical Problem

The disclosure herein discloses a method of producing a magnetic material of compound having magnetocaloric effect. The method may comprise: producing a product by reacting a raw material that is to constitute the magnetic material in melt including an alkali metal; and removing the alkali metal after the product is cooled.

According to the above-described production method, the alkali metal that is not to constitute the magnetic material is melted together with the raw material that is to constitute the magnetic material when the raw material is reacted. By reacting the raw material that is to constitute the magnetic material in the melt including the alkali metal, a reaction temperature can be lowered to or lower than a peritectic temperature, as compared to a case that does not use the alkali metal. Due to this, when the obtained product is cooled, phase separation in a structure of the product is prevented. That is, a single-phase product (magnetic material) can be obtained without performing a heat treatment after the cooling. A production time for the magnetic material can be significantly reduced, as compared to conventional techniques that require a heat treatment after solidification. Further, since phase separation does not occur in the structure in a production process according to the above-described production method, structure uniformity is improved as compared to conventional production methods that make a structure with separated phases into a structure with a single phase. It should be noted that “alkali metal that is not to constitute the magnetic material” means that the alkali metal does not constitute a crystal of the compound. Meanwhile, there may be a case where the magnetic material includes, for example, unavoidable alkali metal, the alkali metal that remains in the compound without being removed after the cooling and the like.

### BRIEF DESCRIPTION OF DRAWINGS

FIG. 1 shows a schematic diagram of a device configured to produce a magnetic material; and

FIG. 2 shows a flowchart for a method of producing the magnetic material.

### DESCRIPTION OF EMBODIMENTS

Some of the features characteristic to the technique disclosed herein will be listed below. It should be noted that the technical elements described below are independent of one another, and are useful solely or in combinations.

The disclosure herein discloses a method of producing a magnetic material of compound having magnetocaloric effect. The magnetic material may be used, by itself or as a mixture with another material, for a magnetic member in a magnetic refrigerator.

The production method disclosed herein may be applied to producing a compound (magnetic material) represented by a following formula (1).

La₁₋ₐAₐ(Fe_{b}Si_{1-b}B_{1-b-c})₁₃C_{d} Formula (1):

In the formula, “A” is at least one element selected from Ce (cerium), Pr (praseodymium) and Nd (neodymium); “B” is at least one element selected from Al (aluminum), Mn (manganese), Co (cobalt), Ni (nickel) and Cr (chromium); “C” is at least one element selected from B (boron) and H (hydrogen); and “a”, “b”, “c” and “d” satisfy 0≤a≤1, 0.8≤b≤0.92, 0.08≤c≤0.2, and 0≤d≤1.

By adjusting the aforementioned element A, element B, element C and element ratios a, b, c and d, a temperature range within which a magnetocaloric effect characteristic of the magnetic material occurs can be adjusted and a magnetostrictive characteristic (a phenomenon where a crystal deforms) can be adjusted. The production method disclosed herein is useful especially for producing a compound represented by La (Fe_{b} Si_{1-b})₁₃ (0.8≤b≤0.92) among compounds represented by the formula (1).

Further, the production method disclosed herein may be applied to producing a quaternary compound (magnetic material) represented by a following formula (2).

(AₓB₁₋ₓ)_{2+y}(C_{z}D_{1-z}) Formula (2):

In the formula, “A” is Mn or Co; “B” is Fe (iron), Cr or Ni; “C” is P (phosphorus), B, Se (selenium), Ge (germanium), Ga (gallium), Si (silicon), Sn (tin), N (nitrogen), As (arsenic) or Sb (antimony); “D” is Ge or Si; and “x”, “y” and “z” satisfy 0<x<1, −0.1≤y≤0.1 and 0≤z≤1.

By adjusting the element A, element B, element C, element D and element ratios x, y and z, in compounds represented by the formula (2) as well, a temperature range within which a magnetocaloric effect characteristic of the magnetic material occurs can be adjusted and the magnetostrictive characteristic can be adjusted. The production method disclosed herein is useful especially for producing a compound represented by (Mnₓ Fe₁₋ₓ) (P_{z} Si_{1-z}) (0<x<1 and 0<z<1) among compounds represented by the formula (2).

The production method disclosed herein may comprise producing a product by reacting a raw material that is to constitute a magnetic material (compound) in melt including an alkali metal; and removing the alkali metal after the product is cooled. By adding the alkali metal to the raw material that is to constitute the magnetic material, a reaction temperature for the raw material mixture can be set lower than a reaction temperature for a raw material mixture including only the raw materials that are to constitute the magnetic material. Since the raw material mixture can be reacted at a low temperature equal to or lower than a peritectic temperature and the product can thereby be obtained, phase separation is suppressed in a structure of the product when the product is cooled. Further, since the phase separation in the structure is prevented, there is no need to perform a heat treatment (annealing treatment) to uniformize the structure (to make separated phases into a single phase) after cooling, by which a production time can be reduced. Even by performing the heat treatment, it is difficult to make a phase-separated structure into a single-phase structure perfectly. Since the single-phase structure can be obtained after the cooling according to the production method disclosed herein, the magnetic material with a uniform structure can be obtained, as compared to production methods that require a heat treatment after the cooling. The alkali metal is used as a flux. The production method disclosed herein can be referred to as a production method using a flux method.

The raw material mixture of the elements that are to constitute the magnetic material and the alkali metal may be reacted in a container such as a crucible. A material of the container may be a metal with a high melting point such as tantalum (Ta), tungsten (W), molybdenum (Mo) and the like; an oxide such as alumina (Al₂O₃), yttria (Y₂O₃) and the like; a nitride ceramics such as aluminum nitride (AlN), titanium nitride (TiN), zirconium nitride (ZrN), boron nitride (BN) and the like; a carbide of a metal with a high melting point such as tungsten carbide (WC), tantalum carbide (TaC) and the like; or a pyrolysate such as pyrolytic boron nitride (p-BN), pyrolytic graphite (p-Gr) and the like. The material of the container may be selected appropriately depending on a melting point and/or a melting condition of the raw material to be melted. Among the aforementioned materials, alumina (including sapphire) is suitably used.

The magnetic material (compound) may be produced in a heating device that is disposed in the above-described container and is configured to heat the raw material mixture. The heating device may be a heating furnace of atmosphere-pressurizing type such as a hot isostatic press device and the like. The container may be disposed under inactive gas atmosphere in producing the magnetic material, although not particularly limited so. The inactive gas may be argon, helium, neon, hydrogen and the like. The atmosphere under which the container is disposed may be pressurized in producing the magnetic material. A pressure of the atmosphere may be in a range of 0.1 MPa or more to 200 MPa or less; may be in a range of 0.1 MPa or more to 100 MPa or less; may be in a range of 0.1 MPa or more to 50 MPa or less; or may be in a range of 0.1 MPa or more to 10 MPa or less. A temperature of an atmosphere in the heating device (a melting temperature) may be appropriately adjusted depending on a type of the magnetic material to be produced.

The heating device may comprise a plurality of heat generators arranged in up-down direction. The heat generators may be controlled individually. That is, each of the heat generators may be zone-controlled. Due to this, generation of a temperature difference can be prevented in the melt in the container in the up-down direction. A material of the heat generators may be heating elements of an alloy such as iron-chromium-aluminum (Fe—Cr—Al) alloy, nickel-chromium (Ni—Cr) alloy and the like; heating elements of a metal with a high melting point such as platinum (Pt), molybdenum (Mo), tantalum (Ta), tungsten (W) and the like; or heating elements of a non-metal such as silicon carbide (SiC), molybdenum silicide (MoSi₂), carbon (C) and the like, although not particularly limited thereto.

In the process of removing the alkali metal, the product after the cooling may be treated with a solvent to dissolve the alkali metal from the product. The product may be submerged in the solvent to dissolve the alkali metal from the product. As the solvent, an organic solvent, such as an alcohol, an organic acid, a phenol and the like, may be used. As the alcohol, methanol, ethanol, glycerin and the like may be used. As the organic acid, acetic acid, citric acid and the like may be used.

In a case of producing the magnetic material represented by La (Fe_{b} Si_{1-b})₁₃ (0.8≤b≤0.92), a raw material mixture that includes at least a La raw material, a Fe raw material, a Si raw material and an alkali-metal raw material is melted.

As the La raw material, a simple substance of La may be used, or a La alloy such as lanthanum silicide (LaSi₂) and the like may be used. In terms of easy handling, the La raw material may be the simple substance of La.

As the Fe raw material, a simple substance of Fe may be used, or a Fe alloy such as iron silicide (FeSi₂) and the like may be used. In terms of easy handling, the Fe raw material may be the simple substance of Fe.

As the Si raw material, a simple substance of Si may be used, or a Si alloy such as the aforementioned lanthanum silicide, iron silicide and the like may be used. In terms of easy handling, the Si raw material may be the simple substance of Si.

Among La, Fe and Si, La and Si melt into the alkali metal at low temperatures that are lower than melting points of their simple substances. However, Fe hardly melts into the alkali metal at a low temperature (a temperature lower than a melting point of Fe). A structure of Fe hardly changes when Fe is heated at a temperature equal to or lower than the peritectic temperature. Therefore, Fe may be in a form of powder of 1 to 150 μm in order to increase reactivity with La, Fe and Si. Since the structure of Fe is maintained almost as it is even when Fe is heated at a temperature equal to or lower than the peritectic temperature, a Fe member having a desired shape may be manufactured in advance and then the Fe member may be heated in the container together with La, Si and the alkali metal to manufacture the magnetic material having a desired shape.

Examples of the alkali-metal raw material include simple substances of Li, Na, K, Rb, Cs and Fr. The alkali metal used in the above-described production method may be one or more metals selected from Li, Na, K, Rb, Cs and Fr, or may be one or more metals selected from Li, Na and K. In terms of easy handling, the alkali-metal raw material may be the simple substance of Na.

Further, in a case of producing the magnetic material of La (Fe, Si)₁₃ type represented by the above formula (1), a rare-earth metal such as Ce, Pr and Nd and/or a simple substance of metal such as Al, Mn, Co, Ni and Cr, or a metallic compound may be included in addition to La, Fe, Si and the alkali metal.

In a case of producing the magnetic material of La (Fe, SOD type represented by La (Fe_{b} Si_{1-b})₁₃ (0.8≤b≤0.92), an atmospheric temperature in the heating device may be equal to or higher than 800° C., may be equal to or higher than 850° C., may be equal to or higher than 900° C., may be equal to or higher than 950° C., or may be equal to or higher than 1000° C. Further, the atmospheric temperature may be equal to or lower than 1300° C., may be equal to or lower than 1250° C., may be equal to or lower than 1200° C., may be equal to or lower than 1150° C., may be equal to or lower than 1100° C., may be equal to or lower than 1050° C., may be equal to or lower than 1000° C., may be equal to or lower than 950° C., or may be equal to or lower than 900° C.

In a case of producing the magnetic material represented by (Mnₓ Fe₁₋ₓ)₂ (P_{z} Si_{1-z}) (0<x<1 and 0<z<1), a raw material mixture including at least a Mn raw material, a Fe raw material, a P raw material, a Si raw material and an alkali-metal raw material is heated.

As the Mn raw material, a simple substance of Mn may be used, or a Mn alloy such as manganese silicide (MnSi₂) and the like may be used. In terms of easy handling, the Mn raw material may be the simple substance of Mn.

As the P raw material, a simple substance of P (P₄) such as white phosphorus, red phosphorus, violet phosphorus, black phosphorus and the like may be used, or a phosphorus compound such as iron phosphide, manganese phosphide and the like may be used. In terms of easy handling, the P raw material may be the simple substance of P.

As the Fe raw material, the Si raw material and the alkali-metal raw material, the same raw materials as those used in the case of producing the magnetic material represented by La (Fe_{b} Si_{1-b})₁₃ (0.8≤b≤0.92) may be used.

Similarly to Fe, Mn hardly melts into the alkali metal at a temperature lower than a melting point of Mn. Therefore, Mn may be in a form of powder of 1 to 150 μm in order to increase reactivity with the other raw materials. Alternatively, a raw material of Mn—Fe compound may be used, in stead of using the Mn raw material and the Fe raw material independently. In this case as well, the Mn—Fe compound may be in a form of powder of 1 to 150 μm. A Mn—Fe member having a desired shape may be manufactured in advance by using a powder mixture of the Mn raw material and the Fe raw material that are independent from each other or by using the Mn—Fe compound, and then the Mn—Fe member may be heated in the container together with the other raw materials that are to constitute the magnetic member and the alkali metal to manufacture the magnetic member having a desired shape.

In a case of producing the magnetic material represented by the above formula (2), Co may be used in place of Mn; Cr or Ni may be used in place of Fe; B, Se, Ge, Ga, Si, Sn, N, As or Sb may be used in place of P; and a simple substance or a compound of Ge or the like may be used in place of Si.

In a case of producing the magnetic material represented by the above formula (2) which includes (Mnₓ Fe₁₋ₓ)₂ (P_{z} Si_{1-z}) (0<x<1, 0<z<1), an atmospheric temperature in the heating device may be equal to or higher than 800° C., equal to or higher than 850° C., equal to or higher than 900° C., or equal to or higher than 950° C. Further, the atmospheric temperature may be equal to or lower than 1050° C., equal to or lower than 1000° C., equal to or lower than 950° C., or equal to or lower than 900° C.

### EMBODIMENTS

### First Embodiment

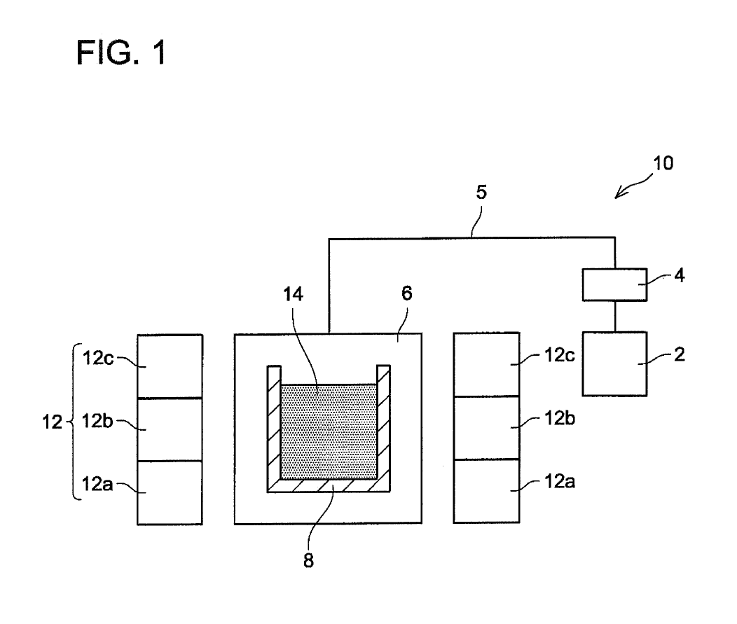

With reference to FIG. 1, a production device for a magnetic material (compound) will be described. A production device 10 includes a heating chamber 6, a container 8 disposed in the heating chamber 6 and a heater 12. An Ar gas tank 2 is connected to the heating chamber 6 via a pipe 5. Ar gas is supplied to the heating chamber 6 through the pipe 5. The pipe 5 is provided with a pressure adjuster 4. The pressure adjuster 4 is configured to adjust a pressure in the heating chamber 6. The container 8 accommodates a raw material mixture 14 of a raw material that is to constitute the magnetic material and an alkali metal. The heater 12 includes heat generators 12a, 12b, 12c. Amounts of heat generation (temperatures) of the heat generators 12a, 12b, 12c can be controlled individually. By controlling the heat generators 12a, 12b, 12c individually, temperature differences are prevented from being caused at respective positions in melt 14.

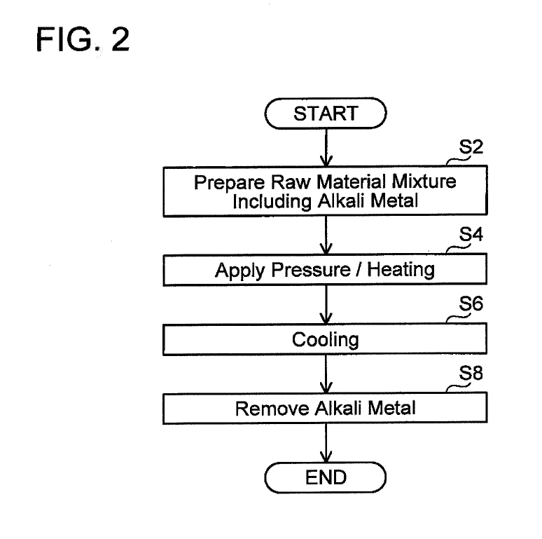

With reference to FIG. 2, an example of producing a magnetic material of La (Fe, Si)₁₃ will be explained. The magnetic material of La (Fe, Si)₁₃ was produced by the production device 10 in FIG. 1.

Firstly, the raw material mixture including the alkali metal was prepared (step S2). Specifically, 41.2 g (1.79 mols) of Na, 2.12 g (0.015 mols) of La, 10 g (0.170 mols) of Fe and 0.67 g (0.024 mols) of Si were weighed in a glove box and these raw materials were accommodated in an alumina crucible (container) 8 having an inner diameter of 100 mm. As the Fe raw material, powder with a particle diameter of 75 μm or less was used.

Next, as shown in step S4, the crucible was placed in the heating chamber 6 and Ar gas was supplied to the heating chamber 6 from the Ar gas tank 2. The Ar gas was supplied such that the pressure in the heating chamber 6 became 1 MPa by using the pressure adjuster 4. After the supply of the Ar gas, the heater 12 was activated and a temperature was maintained at 1050° C. for 12 hours. During the above, the heat generators 12a, 12b, 12c were controlled individually to prevent variations in temperature of the melt 14. By maintaining the temperature at 1050° C. for 12 hours, a product (magnetic material of La (Fe, Si)₁₃) including molten Na is produced.

After completion of the heating, the product was cooled naturally to a room temperature (step S6). After the cooling, the crucible (container) 8 was taken out from the heating chamber 6 and the product was submerged in ethanol for one hour to dissolve Na from the product (step S8). The magnetic material of La (Fe, Si)₁₃ was thereby obtained.

As a result of a crystal identification by X-ray diffraction (XRD) performed to the obtained product (the magnetic material), it was identified as La (Fe, Si)₁₃ of NaZn₁₃ type (cubical crystal). Further, as a result of a composition analysis with X-ray fluorescence performed to the obtained product, it was confirmed as La (Fe_{0.88}Si_{0.12})₁₃. The product included Na only in 10 ppm.

### Second Embodiment

An example of producing a magnetic material of (Mn, Fe)₂ (P, Si) will be explained. The magnetic material of (Mn, Fe)₂ (P, Si) was also produced by the production device 10 in FIG. 1 according to the flow in FIG. 2.

Firstly, 41.2 g (1.79 mols) of Na, 5.9 g (0.11 mols) of Mn, 4 g (0.07 mols) of Fe, 2.1 g (0.07 mols) of P and 0.63 g (0.02 mols) of Si were weighed in a glove box and these raw materials were accommodated in the alumina crucible (container) 8 having the inner diameter of 100 mm. As the Mn raw material and the Fe raw material, powders with a particle diameter of 75 μm or less were used.

The Ar gas was supplied to the heating chamber 6 from the Ar gas tank 2 such that the pressure in the heating chamber 6 became 1 MPa by using the pressure adjuster 4. Then, the heater 12 was activated not to cause variations in temperature of the melt 14 and the temperature was maintained at 650° C. for 12 hours, by which a product was obtained. After completion of the heating, the obtained product was cooled naturally to a room temperature and then it was submerged in ethanol for one hour to dissolve Na from the product. The magnetic material of (Mn, Fe)₂ (P, Si) was thereby obtained.

As a result of a crystal identification by X-ray diffraction (XRD) performed to the obtained product (the magnetic material), it was identified as (Mn, Fe)₂ (P, Si) of Fe₂P type (hexagonal crystal). Further, as a result of a composition analysis with X-ray fluorescence performed to the obtained product, it was confirmed as (Mn_{0.6}Fe_{0.4})₂(P_{0.75}Si_{0.25}). The product included Na only in 10 ppm.

As described in the first and second embodiments, by heating the raw materials that are to constitute the magnetic material together with the alkali metal (Na) to react them, cooling the product and then removing the alkali metal from the product, the single-phase magnetic material was obtained without heat-treating the product after the cooling.

For example, in a case of producing a La (Fe, Si)₁₃ compound, it is conventionally necessary to react raw materials at a temperature that is higher than respective temperatures of the raw materials, and the reaction temperature is approximately 1500° C. In a case of producing a (Mn, Fe)₂(P, Si) compound, the reaction temperature is approximately 1100° C. Further, since the product includes separated phases, it is necessary to perform a heat treatment (annealing treatment) for several dozen hours to several hundred hours at a temperature lower than the reaction temperature after the product has been cooled, in order to uniformize the separated phases (to make the separated phases into a single phase). Further, even by the heat treatment, it was difficult to achieve a perfect uniformity. Since the phase separation further progresses when a temperature for the heat treatment is increased in order to reduce the production time, there was a limit to the heat treatment temperature.

As described in the embodiments above, by reacting the raw materials that are to constitute the magnetic material in the melt including the alkali metal (Na), the reaction temperature of the raw material mixture can be significantly lowered and the phase separation can be suppressed in the structure of the product. Since the single-phase product can be obtained after the cooling, a heat treatment after the cooling can be omitted, by which the production time of the magnetic material can be significantly reduced. Thus, the magnetic material with high uniformity can be produced in a short period of time. In the embodiments above, an amount of the alkali metal in the product is a few ppm and it does not affect characteristics of the magnetic material.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

1. A method of producing a magnetic material of compound having magnetocaloric effect, the method comprising:
producing a product by reacting a raw material that is to constitute the magnetic material in melt including an alkali metal; and
removing the alkali metal after the product is cooled.

2. The method according to claim 1, wherein the alkali metal includes at least Na.

3. The method according to claim 2, wherein the magnetic material is a compound represented by a following formula (1),
La₁₋ₐAₐ(Fe_{b}Si_{1-b}B_{1-b-c})₁₃C_{d} Formula (1):
where “A” is at least one element selected from Ce, Pr and Nd; “B” is at least one element selected from Al, Mn, Co, Ni and Cr; “C” is at least one element selected from B and H; and “a”, “b”, “c” and “d” satisfy 0≤a≤1, 0.8≤b≤0.92, 0.08≤c≤0.2, and 0≤d≤1.

4. The method according to claim 3, wherein the magnetic material is a compound represented by La (Fe_{b} Si_{1-b})₁₃, where “b” satisfies 0.8≤b≤0.92.

5. The method according to claim 1, wherein the magnetic material is a compound represented by a following formula (1),
La₁₋ₐAₐ(Fe_{b}Si_{1-b}B_{1-b-c})₁₃C_{d} Formula (1):
where “A” is at least one element selected from Ce, Pr and Nd; “B” is at least one element selected from Al, Mn, Co, Ni and Cr; “C” is at least one element selected from B and H; and “a”, “b”, “c” and “d” satisfy 0≤a≤1, 0.8≤b≤0.92, 0.08≤c≤0.2, and 0≤d≤1.

6. The method according to claim 5, wherein the magnetic material is a compound represented by La (Fe_{b} Si_{1-b})₁₃, where “b” satisfies 0.8≤b≤0.92.

7. The method according to claim 1, wherein the magnetic material is a quaternary compound represented by a following formula (2),
(AₓB₁₋ₓ)_{2+y}(C_{z}D_{1-z}) Formula (2):
where “A” is Mn or Co; “B” is Fe, Cr or Ni; “C” is P, B, Se, Ge, Ga, Si, Sn, N, As or Sb; “D” is Ge or Si; and “x”, “y” and “z” satisfy 0<x<1, −0.1≤y≤0.1 and 0<z<1.

8. The method according to claim 7, wherein the magnetic material is a compound represented by (Mnₓ Fe₁₋ₓ)₂ (P_{z}Si_{1-z}), where “x” and “z” satisfy 0<x<1 and 0<z<1.

9. The method according to claim 2, wherein the magnetic material is a quaternary compound represented by a following formula (2),
(AₓB₁₋ₓ)_{2+y}(C_{z}D_{1-z}) Formula (2):
where “A” is Mn or Co; “B” is Fe, Cr or Ni; “C” is P, B, Se, Ge, Ga, Si, Sn, N, As or Sb; “D” is Ge or Si; and “x”, “y” and “z” satisfy 0<x<1, −0.1≤y≤0.1 and 0<z<1.

10. The method according to claim 9, wherein the magnetic material is a compound represented by (MnₓFe₁₋ₓ)₂(P_{z}Si_{1-z}), where “x” and “z” satisfy 0<x<1 and 0<z<1.
